(19) United States
(12) Patent Application Publication
(10) Pub. No.: US 2016/0327210 A1
(43) Pub. Date: Nov. 10, 2016

(54) REVERSIBLE H2 STORAGE SYSTEM WITH A TANK CONTAINING METAL HYDRIDES, WITH PRESSURE BALANCING

(71) Applicant: COMMISSARIAT A L'ENERGIE ATOMIQUE ET AUX ENERGIES ALTERNATIVES, Paris (FR)

(72) Inventors: Albin CHAISE, Grenoble (FR); Olivier GILLIA, Sassenage (FR)

(73) Assignee: COMMISSARIAT A L'ENERGIE ATOMIQUE ET AUX ENERGIES ALTERNATIVES, Paris (FR)

(21) Appl. No.: 15/109,755

(22) PCT Filed: Dec. 23, 2014
(86) PCT No.: PCT/IB2014/067272

§ 371 Date: Jul. 5, 2016

(30) Foreign Application Priority Data
Jan. 2, 2014 (FR) 1450008

(51) Int. Cl. F17C 11/00; H01M 8/04007; H01M 8/065

(52) U.S. Cl. CPC F17C 11/005; H01M 8/065; H01M 8/04007; F17C 2221/012; F17C 2205/0338; F17C 2227/0309; F17C 2227/0323; F17C 2270/0184; F17C 2260/031; H01M 2250/20

(57) ABSTRACT

A reversible H2 storage system includes: a hydrogen storage tank including an enclosure containing metal hydrides incorporated into a heat exchanger having two fluid circuits, referred to as the primary exchanger, a hydrogen circulation circuit, referred to as the first circuit, linked to the inside of the enclosure, to supply or recover the H2 respectively to be absorbed or desorbed by the metal hydrides, the part of the first circuit inside the enclosure forming one of the exchanger circuits, a circuit for the circulation of a heat-transfer fluid, referred to as the second circuit, linked to the exchanger, the part of the second circuit in the exchanger forming the other of the circuits of the exchanger, the first and second circuits being sealed relative to each other, a pressurising device for bringing the pressure value in the second circuit to a value close to that in the first circuit.

### TECHNICAL FIELD

The present invention relates to a system for the reversible storage of hydrogen H2 in solid form, comprising a tank the vessel of which contains a heat exchanger which contains metal hydrides.

The present invention seeks to simplify the design and production of the integrated heat exchanger.

The possible applications of the invention are numerous and may relate to the entire field of hydrogen storage applications.

This may be H2 storage systems with tanks dedicated to means of transport, such as boats, submarines, motor cars, buses, trucks, site vehicles, two-wheeled vehicles and systems from the field of portable power supplies, such as batteries for mobile electronic devices (mobile telephones, laptop computers, etc.).

This may also be stationary systems for the storage of H2 in larger quantities, such as electric generator sets, the storage of H2 produced by intermittent energy (wind turbines, photovoltaic panels, geothermal, etc.).

In general, the system according to the invention may be used solely for the purposes of transporting hydrogen, but it may also be used for the on-board storage of hydrogen for a fuel cell or combustion engine or even for stationary hydrogen storage.

### PRIOR ART

Because, notably, of the depletion of crude oil reserves, alternative energy sources are being sought. One of the promising vehicles carrying these energy sources is hydrogen which can be used in fuel cells to produce electricity.

Hydrogen is an element which is present very extensively throughout the universe and on earth; it can be produced from coal, natural gas or other hydrocarbons but may also be produced by simple electrolysis of water using, for example, electricity produced by solar or wind energy.

Fuel cells operating on hydrogen are already used in certain applications, for example in motor vehicles, but are still not very widely adopted notably because of the precautions that have to be taken and the difficulties associated in storing the hydrogen.

In order to reduce the storage volume, the hydrogen can be stored in the form of compressed gaseous hydrogen at between 350 and 700 bar, but this densification of the energy can be further improved by incorporating hydrides into the pressure vessel.

In order to be even denser yet, the hydrogen may also be stored in liquid form, although this storage provides only a low storage efficiency and does not allow for long-term storage. The transition of a volume of hydrogen from the liquid state to the gaseous state under normal pressure and temperature conditions produces an increase in volume by a factor of around 800. Tanks that store hydrogen in liquid form are generally not very able to withstand mechanical impact and that poses significant safety problems.

There is also the ability to store hydrogen in solid form using hydrides. This storage allows for a high volumetric storage density while at the same time minimizing the energy impact of storage on the overall efficiency of the hydrogen chain, i.e. from its production to its conversion into another energy.

The principle of solid storage of hydrogen in the form of hydrides is as follows: certain materials and, in particular, certain metals, have the ability to absorb hydrogen to form a hydride, this reaction is called absorption. The hydrides formed can once again revert to gaseous hydrogen and a metal. This reaction is called desorption. Absorption or desorption occur depending on the partial pressure of hydrogen and on the temperature.

Use is made, for example, of a metal powder that is brought into contact with hydrogen, an absorption phenomenon occurs and a metal hydride is formed. The release of the hydrogen occurs according to a desorption mechanism.

The storage of the hydrogen is an exothermal reaction, i.e. one which releases heat, whereas the release of the hydrogen is an endothermal reaction, i.e. a reaction that absorbs heat.

It is notably the object to have a rapid charging of the metal powder with hydrogen. In order to obtain such rapid charging, the heat produced during this charging needs to be removed in order to prevent it slowing the absorption of hydrogen onto the powder or the metal matrix. During the discharging of hydrogen, heat is applied. As a result, the effectiveness of the cooling and of the heating govern the charging and discharging rates.

In other words, it is necessary to remove heat during absorption and to supply heat during desorption in order to facilitate the reactions and increase the efficiency of the hydride in terms of the flow rate of hydrogen entering or leaving the storage tank. Thus, a tank of hydrogen in the form of metal hydrides generally comprises a vessel containing the hydrides and within it incorporates a heat exchanger.

The design and sizing of this integrated exchanger need to meet a number of key criteria that can be listed as follows:
It needs to produce an effective exchange of heat. Specifically, in the tank, the hydride is in the form of powder with limited thermal conductivity. The sizing of the tank needs to take into consideration the hydrogen flow rates that are to be assured;
The absorption of hydrogen by the metal leads to an increase in the volume of this metal. There are two consequences of this. First, because of its fragile behavior, the metallic material crumbles into a fine powder. This phenomenon is called decrepitation. Second, because of the swelling, the material applies mechanical pressure to the walls of its container. In order to limit these stresses, the hydride may be compartmentalized into cells of suitable dimensions in particular avoiding the creation of vertically long and thin cells, the vertical being defined by gravity.
The hydrogen pressure in the tank varies, notably with hydrogen pressure increases. The tank therefore has to be able to withstand such variations.

Another problem arises when the difference in the pressure between that of the hydrogen gas in the tank and that of the heat-transfer fluid in the integrated exchanger is very different. In general, the heat-transfer fluid is at a pressure of a few bar, whereas the hydrogen may be at a far higher pressure, for example 350 bar.

The high hydrogen pressure is therefore applied to the outside of the pipes of the heat-transfer fluid circuit, which places extremely high mechanical stress on these pipes within the integrated exchanger.

The existing solution requires very substantial pipe wall thicknesses. For example a cylindrical tube subjected to a high external pressure is engineered against buckling, and its wall thicknesses are therefore very great, something which, on the one hand, makes the hydrogen storage tank heavier and more expensive and, on the other hand, is detrimental to a good transfer of heat between the hydride and the heat-transfer fluid, because the thermal resistance increases with the wall thickness of the heat-transfer fluid circulation pipes.

There is therefore a need to improve further the systems for the reversible storage of hydrogen with a tank containing metal hydrides and incorporating a heat exchanger within it notably with a view to improving the heat transfer between the metal hydride or hydrides and the hydrogen, and reducing the mass and production cost of the tank.

The object of the invention is to satisfy this requirement, at least in part.

### SUMMARY OF THE INVENTION

In order to do this, one subject of the invention is a reversible hydrogen-storage system comprising:
A hydrogen storage tank comprising a vessel containing metal hydrides incorporated into a heat exchanger with two fluid circuits, referred to as the primary exchanger,
A hydrogen circulation circuit, referred to as the first circuit, connected into the inside of the vessel in order to supply or recover the hydrogen H₂ that is respectively to be absorbed or desorbed by the metal hydrides, the part of the first circuit inside the vessel constituting one of the exchanger circuits,
A heat-transfer fluid circulation circuit, referred to as the second circuit, connected to the exchanger, the part of the second circuit in the exchanger constituting the other of the circuits of the exchanger, the first and second circuits being sealed with respect to one another,
A pressurizing means for bringing the pressure in the second circuit to a value close to that in the first circuit.

A <<heat exchanger>> here and within the context of the invention means a device comprising at least one tube of any cross section through which a heat-transfer fluid circulates and which is arranged at least partially in a bed of metal hydride powder inside the vessel. Heat-conducting elements such as fins, filaments, a metal foam, etc. may be connected to a heat exchanger tube according to the invention.

A <<value close to>> here and within the context of the invention means a substantially equal pressure value in the first and second circuits, with a difference typically of 1 bar or even 2 to 3 bar, or even of the order of around ten bar.

It is emphasized that the first circuit provides direct contact between the hydrogen and the hydride material.

Thus, the invention essentially consists in reducing the difference in pressure between the two fluids, the hydrogen and the heat-transfer fluid, within the tank to small values.

Within the context of the invention, it is the pressure of the hydrogen that is the deciding factor notably because the hydrogen may be compressed to high pressures, typically to 350 bar or beyond, typically up to 1000 bar in order to be stored in stationary tanks. As a result, the invention consists in pressurizing the heat-transfer fluid so that it reaches at least the pressure of the hydrogen.

The fact of reducing this pressure difference makes it possible to conceive of lightening the structures of the heat exchangers integrated into the hydrogen tanks by using tubes with thinner walls. Having thinner walls offers two major advantages, namely first a reduction in weight and second a reduction in thermal resistance, because the entire heat flux passes across this tube wall. This is an undeniable advantage in the case of on-board tanks, and in general affords improvements in terms of gains of efficiency and savings on cost.

Another advantage is the ability to adopt heat exchanger tube shapes that are non-circular. It is thus possible advantageously to conceive of tubes of square, rectangular, triangular, oblong, cross-shaped cross section or even of four-arm or multi-arm star-shaped cross section. These latter star-shaped cross sections have the notable advantages of increasing the heat-exchange surface area and of being easier to integrate into the heat exchanger.

The heat-transfer fluid may be at a pressure close to that of the hydrogen.

Advantageously, for a tube of circular cross section, the pressure of the heat-transfer fluid is slightly higher than that of hydrogen. Thus, the pipes (tubes) of an exchanger integrated into the tank are in an internal-pressure mechanical-stress mode, namely are stressed from the inside of the pipes toward the outside within the tank vessel, rather than being in an external-pressure stress mode which presents problems of buckling. The internal-pressure stressing is far easier to master.

Thus, for preference, it is preferable for the heat-transfer fluid to be at a higher pressure than the H₂ gas.

In other words, the sizing of the heat exchange is easier.

In other words still, by virtue of the invention, the design and creation of the exchanger integrated within the hydrogen tank is simplified, it being possible for this exchanger to be more compact, more lightweight and perform better than an exchanger according to the prior art.

For preference, the heat-transfer fluid is a liquid, preferably based on water, notably containing glycol or the like.

According to one advantageous embodiment, the pressurizing means may consist in the tube or tubes of the heat exchanger, the cross section of the tube or tubes of the exchanger being designed so as to deform enough to bring the pressure in the second circuit to a value close to that in the first circuit. In other words, it is possible according to this embodiment to conceive of the pressure-equalizing being performed by the deformation of the cross section of the tube of the exchanger itself, taking on the role of a flexible membrane. For example, a tube with a star-shaped cross section has the ability to deform easily, and thus to transmit pressure from the first circuit to the second circuit.

Alternatively or in combination, according to another advantageous embodiment, the pressurizing means consisting in a pressure equalizer consisting of a vessel inside which there is fixed a mobile element dividing a first chamber from a second chamber in a sealed manner, the first chamber being connected to the first circuit, the second chamber being connected to the second circuit.

The mobile element may be a flexible membrane or a piston. Rather than a membrane or piston accumulator, it is also possible to conceive of a compressor for pressurizing the heat-transfer fluid circuit. In that case, a feedback control circuit is additionally provided to ensure that the pressure supplied by the compressor mirrors that of the hydrogen.

According to a first alternative form, the pressurizing means is arranged outside the H₂ storage tank.

According to a second alternative form, the pressurizing means is arranged inside the vessel of the H₂ storage tank.

According to one advantageous embodiment, the second circuit comprises a first pump and another heat exchanger constituting a first secondary exchanger. With this embodiment, the secondary fluid of the secondary exchanger is advantageously a liquid, preferably water, or a gas, preferably air.

Another aspect of the invention relates to a method for operating a system described previously, comprising a permanent pressurization step for bringing the pressure in the second circuit to a value close to that in the first circuit.

The pressurizing step is preferably performed automatically.

Advantageously, the pressure in the second circuit is higher than that of the first circuit.

For preference, the pressure in the first circuit is at least equal to 350 bar, that in the second circuit being around 2 to 3 bar higher.

The invention also relates to an electrical power supply unit comprising a fuel cell and a system described previously, the first secondary heat exchanger being connected to the fuel cell in such a way that the heat given off by the fuel cell in operation allows the desorption of hydrogen in the tank.

The invention finally relates to a stationary installation for refilling a unit as claimed in claim 14 with hydrogen, the installation comprising a second pump and a second secondary heat exchanger, the second pump and the second secondary heat exchanger being intended to be connected to the second circuit while the tank is being refilled with H₂.

### DETAILED DESCRIPTION

Other features and advantages of the invention will become better apparent from reading the detailed description of some exemplary embodiments of the invention, given by way of illustrative nonlimiting example with reference to the following figures among which:

FIG. 1 is a schematic view of an example of a reversible hydrogen storage system according to the invention;

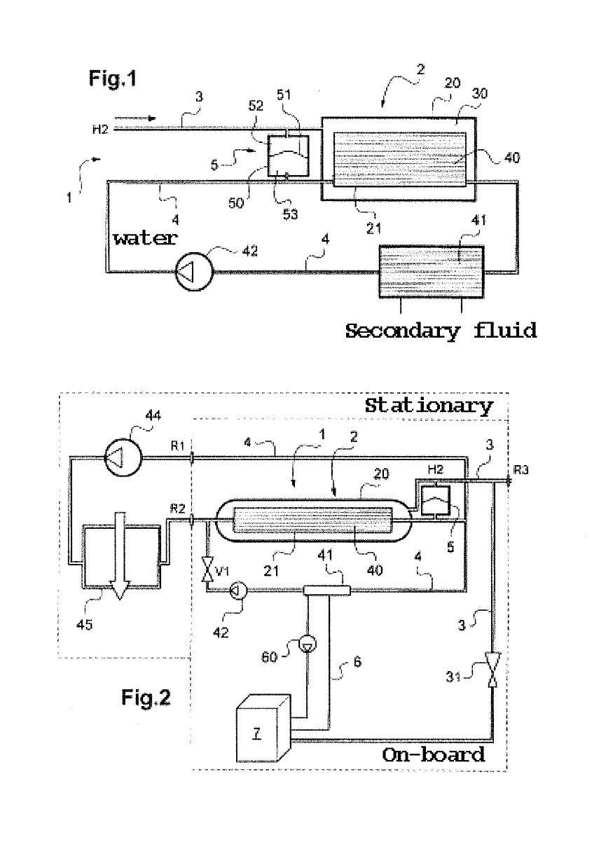

FIG. 2 is a schematic view of a unit for an on-board application, such as for carrying on board a motor vehicle, comprising a fuel cell and a reversible hydrogen storage system according to the invention, the connection of the unit in a stationary application also being depicted;

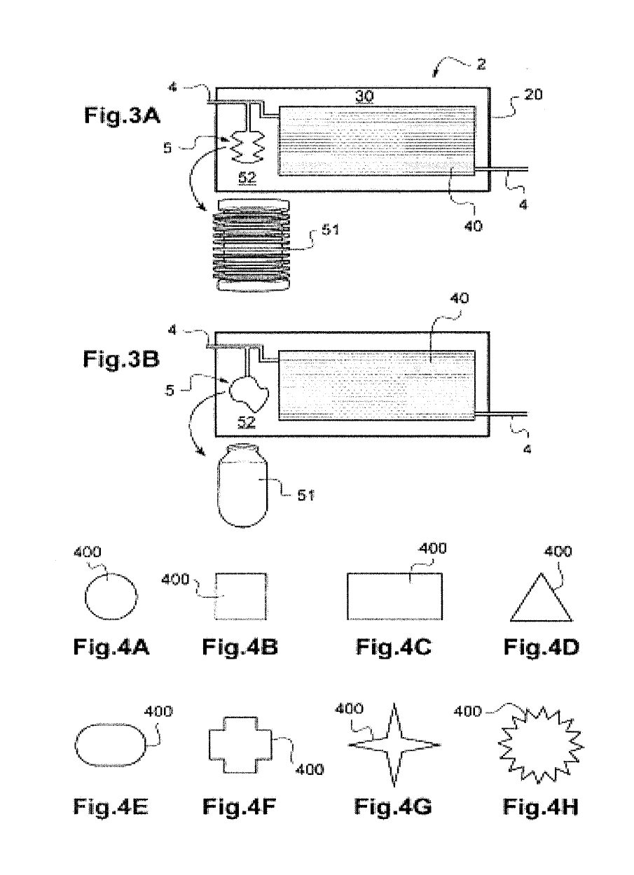

FIGS. 3A and 3B are schematic views of alternative forms of a layout of the pressurizing means of a reversible hydrogen storage system according to the invention;

FIGS. 4A to 4H illustrate views in cross section of various alternative forms of heat exchanger tube shapes that can be used in a reversible hydrogen storage system according to the invention.

FIG. 1 depicts a reversible hydrogen H₂ storage system 1 according to the invention.

The system 1 first of all comprises a storage tank 2 comprising a vessel 20 containing metal hydrides, not depicted, and incorporating within it a heat exchanger 21 constituting a primary exchanger.

A hydrogen circulation circuit 3 is connected to the inside of the vessel 20 in order to supply or recover the hydrogen H₂ that is respectively to be absorbed or desorbed by the metal hydrides. The part 30 of the circuit 3 inside the vessel 20 constitutes one of the circuits of the primary exchanger 21. The circuit 3 ensures direct contact between the hydrogen and the hydride.

A heat-transfer liquid circulation circuit 4 is connected to the exchanger 21, the part 40 of this circuit 4 in the exchanger constituting the other of the circuits of the exchanger 21. This circuit 4 therefore has the function of being a cooling loop referred to as the primary cooling loop that enters the inside of the vessel 20 and re-emerges therefrom. In order to exchange heat with a secondary fluid, preferably a liquid, there is, within this loop 4, a secondary heat exchanger 41. The circulation of liquid within the loop 4 is ensured by a pump 42.

According to the invention, the loop 4 is pressurized to a pressure close to the hydrogen supply pressure, i.e. the pressure prevailing in the circuit 3 and in the vessel 20 of the tank 2 by means of a pressure equalizing means 5 arranged outside the tank 2.

As illustrated in FIGS. 1 and 2, the pressure equalizing means 5 consists of an accumulator of the flexible membrane or piston type. Thus, it is made up of a vessel 50 inside which is fixed a flexible membrane 51 separating two chambers 52, 53 in leak tight manner. The first chamber 52 is connected to the hydrogen supply/recovery circuit 3. The second chamber 53 is itself connected to the cooling loop 4.

By way of advantageous example, the system 1 shown in FIG. 1 allows hydrogen to be stored in the tank 2 at a pressure of 350 bar hydrogen. The maximum hydrogen pressure increase may be 350 bar in a time of 1 to 1.5 min. The tank 2 may have a storage capacity of the order of 1.5 kg of H₂.

With the membrane accumulator 5, the water circulating in the loop 4 may be at a higher pressure of the order of 2 to 3 bar higher.

Suitable cooling may be obtained with a water flow rate during the charging of H₂, of the order of 1 liter/second, the water temperature varying between 10 and 75° C.

With the membrane accumulator 5 according to the invention, the pressure difference between the heat-transfer circuit 4 and the hydrogen in the heat exchanger 21 integrated into the tank 2 is thus smaller.

However, care should be taken to ensure that the secondary heat exchanger 41 is capable of generating a greater pressure difference because it exchanges with a weakly pressurized circuit, a water or air circuit for example. Now, this greater pressure difference to be planned for on the secondary exchanger 41 does not present any disadvantage because:
first it does not contain any hydride, and its design is therefore simplified and even great pressure differences can easily be achieved by the usual conventional heat exchanger sizing,
second, when the system according to the invention is intended to be of the on-board type, for example carried on board a motor vehicle in order to operate a fuel cell, it is possible to allow for this secondary exchanger 41 not to be carried on board. It may be installed at a fixed location, forming an integral part of a hydrogen filling station. As far as the discharging of hydrogen is concerned, a secondary exchanger 41 is nevertheless required. That being so, for hydrogen being used in a fuel cell in order to operate a vehicle for example, there is no need for high hydrogen flow rates, so the heat flux exchanged is therefore lower, by a factor of around 50 to 100. The secondary exchanger 41 to be carried on board may therefore be much smaller in size than the one for the hydrogen charging phase. A system 1 according to the invention which is carried on board is therefore lighter in weight overall.

FIG. 2 depicts a system 1 according to the invention for an on-board application with a fuel cell 7 with the hydrogen charging being performed under stationary conditions.

Under stationary conditions, high heat fluxes, i.e. high flow rates, are handled by an external heat exchanger 45, the technology of which may be as usual, such as a water/air exchanger for example. The flow rate of water through the circuit 4 is assured by a pump 44 in the charging station.

Thus, in the mode of charging of hydrogen in the station, the valve V1 is closed, the pump 42 is switched off, the pump 44 is in operation, the connections R1, R2, and R3 are connected, the connection R3 allowing hydrogen to be carried into the tank 2.

In discharge mode, i.e. when the on-board fuel cell 7 is in operation, the valve V1 is open, the pump 42 is in operation, the connections R1, R2 and R3 are disconnected and sealed off. The fuel cell 7 is in operation, the pump 60 of the secondary circuit 6 is also in operation. With such a system, the heat lost by the fuel cell 7 is used to cause the hydrogen to desorb from the hydride in the tank 2, via the secondary circuit 6.

Other alternative forms and improvements may be anticipated without thereby departing from the scope of the invention.

Thus, while in the systems 1 depicted in FIGS. 1 and 2 the pressurizing means 5 is arranged outside the vessel 20 of the storage tank 2, it is just as conceivable for the pressurizing means 5 to be arranged inside the vessel 20, as illustrated in FIGS. 3A and 3B. In FIG. 3A, the pressurizing means 5 consists of a pressure accumulator in the form of a mobile piston 51 able to move in the part 30 of the hydrogen circulation circuit within the vessel 2, whereas in FIG. 3B, the accumulator 5 is an accumulator with a flexible membrane 51 in the part 30.

The tubes 400 of the exchanger 40 within the vessel 2 may have different shapes, such as a circular cross section (FIG. 4A), a square (FIG. 4B), a rectangular (FIG. 4C), a triangular (FIG. 4D), an oblong (FIG. 4E), a cross-shaped (FIG. 4F) cross section or even a cross section in the shape of a four-arm (FIG. 4G) or multi-arm (FIG. 4H) star. The latter star-shaped cross sections have the notable advantages of increasing the heat-exchange surface area and of being easier to integrate into the heat exchanger.

The invention is not restricted to the examples that have just been described; notably features of the illustrated examples can be combined with one another in alternative forms that have not been illustrated.

1-15. (canceled)

16. A reversible hydrogen-storage system comprising:
a hydrogen storage tank comprising a vessel containing metal hydrides incorporated into a heat exchanger with two fluid circuits, referred to as the primary exchanger,
a hydrogen circulation circuit, referred to as the first circuit, connected into the inside of the vessel in order to supply or recover the hydrogen H₂ that is respectively to be absorbed or desorbed by the metal hydrides, the part of the first circuit inside the vessel constituting one of the exchanger circuits,
a heat-transfer fluid circulation circuit, referred to as the second circuit, connected to the exchanger, the part of the second circuit in the exchanger constituting the other of the circuits of the exchanger, the first and second circuits being sealed with respect to one another,
a pressurizing means for bringing the pressure in the second circuit to a value close to that in the first circuit.

17. The system as claimed in claim 16, the heat-transfer fluid being a liquid.

18. The system as claimed in claim 16, the pressurizing means consisting in the tube or tubes of the heat exchanger, the cross section of the tube or tubes of the exchanger being designed so as to deform enough to bring the pressure in the second circuit to a value close to that in the first circuit.

19. The system as claimed in claim 16, the pressurizing means consisting in a pressure equalizer consisting of a vessel inside which there is fixed a mobile element dividing a first chamber from a second chamber in a sealed manner, the first chamber being connected to the first circuit, the second chamber being connected to the second circuit.

20. The system as claimed in claim 19, the mobile element being a flexible membrane or a piston.

21. The system as claimed claim 16, the pressurizing means being arranged outside the H₂ storage tank.

22. The system as claimed in claim 16, the pressurizing means being arranged inside the vessel of the H₂ storage tank.

23. The system as claimed in claim 16, the second circuit comprising a first pump and another heat exchanger constituting a first secondary exchanger.

24. The system as claimed in claim 23, the secondary fluid of the secondary exchanger being a liquid or a gas.

25. The system as claimed in claim 24, the secondary fluid of the secondary exchanger being water or air.

26. A method for operating a system as claimed in claim 16, comprising a permanent pressurization step for bringing the pressure in the second circuit to a value close to that in the first circuit.

27. The method as claimed in claim 26, the pressurization step being performed automatically.

28. The method as claimed in claim 26, the pressure in the second circuit being greater than that in the first circuit.

29. The method as claimed in claim 28, the pressure in the first circuit being at least equal to 350 bar, that in the second circuit being around 2 to 3 bar higher.

30. An electrical power supply unit comprising a fuel cell and a system as claimed in claim 23, the first secondary heat exchanger being connected to the fuel cell in such a way that the heat given off by the fuel cell in operation allows the desorption of hydrogen in the tank.

31. A stationary installation for refilling a unit as claimed in claim 30 with hydrogen, the installation comprising a second pump and a second secondary heat exchanger, the second pump and the second secondary heat exchanger being intended to be connected to the second circuit while the tank is being refilled with H₂.
